(19) United States
(12) Patent Application Publication
(10) Pub. No.: US 2010/0166138 A1
(43) Pub. Date: Jul. 1, 2010

(54) X-RAY CT APPARATUS

(76) Inventor: Xiongwei Yan, Beijing (CN)

Correspondence Address: PATRICK W. RASCHE (20459);ARMSTRONG TEASDALE LLP, ONE METROPOLITAN SQUARE, SUITE 2600, ST. LOUIS, MO, 63102-2740, US

(21) Appl. No.: 12/645,155

(22) Filed: Dec. 22, 2009

(30) Foreign Application Priority Data
Dec. 26, 2008 (CN) 200810190654.X

(51) Int. Cl. H05G 1/60

(52) U.S. Cl. 378/4

(57) ABSTRACT

An X-ray CT apparatus includes an X-ray irradiator which irradiates fan-beam X-rays; a multi-channel X-ray detector disposed to face the X-ray irradiator; a transmitted X-ray data collection device which scans a subject while rotating the X-ray irradiator and the X-ray detector to collect transmitted X-ray data of two or more views; a scan control device which controls the scan; and an image reconstruction device which reconstructs an image. The X-ray irradiator irradiates fan-beam X-rays which are deflected to one side of the center of rotation, the X-ray detector has the number of channels to cope with a spread of the fan-beam X-rays, and the scan control device allows the X-ray irradiator and the X-ray detector to conduct a scan of at least one rotation.

### CROSS REFERENCE TO RELATED APPLICATIONS

This application claims the benefit of Chinese Patent Application No. 200810190654.X filed Dec. 26, 2008, which is hereby incorporated by reference in its entirety.

### BACKGROUND OF THE INVENTION

The embodiments described herein relate to an X-ray CT (computed tomography) apparatus and, more particularly, to an X-ray CT apparatus having an X-ray irradiator which irradiates fan-beam X-rays and a multi-channel X-ray detector disposed to face the X-ray irradiator.

At least some known X-ray CT apparatuses conduct a scan on a subject by use of an X-ray irradiator which irradiates fan-beam X-rays and a multi-channel X-ray detector disposed to face the X-ray irradiator. Then, the X-ray CT apparatus reconstructs an image based on transmitted X-ray data obtained thereby.

In order to achieve a large scan field of view (FOV) for use in imaging a large subject, a geometry of an X-ray irradiation/detection mechanism must be made larger. Therefore, when considering an economical aspect, it is difficult to obtain a sufficiently large scan FOV.

Therefore, when scanning a subject larger than the scan FOV, the transmitted X-ray data corresponding to a portion extending off the field is produced by estimation. Then, such data and actual data are combined to reconstruct the image (see, for example, Japanese Unexamined Patent Publication No. 2004-065706 (paragraph number [0032], FIG. 6)).

### BRIEF DESCRIPTION OF THE INVENTION

The image reconstructed from the transmitted X-ray data containing the estimated data is inferior in quality to an image reconstructed from the transmitted X-ray data which are all actual data because of a shift of CT values, occurrence of artifacts, etc.

An X-ray CT apparatus is provided with a large scan FOV to realize an X-ray CT apparatus which achieves the large scan FOV and low exposure at the same time.

In a first aspect, there is provided an X-ray CT apparatus comprising: an X-ray irradiator for irradiating fan-beam X-rays; a multi-channel X-ray detector disposed to face the X-ray irradiator; a transmitted X-ray data collection device for collecting transmitted X-ray data of two or more views by scanning a subject while rotating the X-ray irradiator and the X-ray detector; a scan control device for controlling the scan; and an image reconstruction device for reconstructing an image based on the transmitted X-ray data. According to the X-ray CT apparatus, the X-ray irradiator irradiates fan-beam X-rays deflected to one side of the center of rotation. The X-ray detector has a number of channels to cope with a spread of the fan-beam X-rays. The scan control device allows the X-ray irradiator and the X-ray detector to conduct a scan of at least one rotation.

In a second aspect, there is provided an X-ray CT apparatus according to the first aspect, wherein the X-ray irradiator irradiates fan-beam X-rays whose central beam is deflected to one side by an angle equivalent to 1/n of a fan angle relative to the center of the scan in a plane of the fan beam.

In a third aspect, there is provided an X-ray CT apparatus according to the second aspect, wherein the X-ray irradiator irradiates fan-beam X-rays whose central beam is deflected to one side by an angle equivalent to ½ of the fan angle relative to the center of the scan in the plane of the fan beam.

In a fourth aspect, there is provided an X-ray CT apparatus according to the first aspect, wherein the scan control device includes a device to control such that the X-ray are irradiated from the X-ray irradiator in two or more different relative positional relationship between the X-ray irradiator and the X-ray detector, and the image reconstruction device reconstructs an image based on a combination of the transmitted X-ray data at the two or more different relative positions collected by the transmitted X-ray data collection device.

In a fifth aspect, there is provided an X-ray CT apparatus according to the fourth aspect, wherein the scan control device adjusts, in relation to each view, positions of the X-ray focal point of the X-ray irradiator in a scanning trajectory to be the same with respect to two timing, that is, before and after the amount of rotation of the scan becomes equivalent to half of a channel pitch of the X-ray detector.

In a six aspect, there is provided an X-ray CT apparatus according to the fifth aspect, wherein the scan control device adjusts the positions of the X-ray focal point by flying focus.

In a seventh aspect, there is provided an X-ray CT apparatus according to the fifth aspect, wherein the image reconstruction device reconstructs the image based on a combination of transmitted X-ray data obtained when adjusting the positions of the X-ray focal point in respective views.

In an eighth aspect, there is provided an X-ray CT apparatus according to the seventh aspect, wherein the combination of the transmitted X-ray data is the one being interleaved.

In a ninth aspect, there is provided an X-ray CT apparatus according to the first aspect, wherein the X-ray detector is disposed such that it is offset toward channels.

In a tenth aspect, there is provided an X-ray CT apparatus according to ninth aspect, wherein the offset is a 1/n offset.

In an eleventh aspect, there is provided an X-ray CT apparatus according to tenth aspect, wherein the offset is a ¼ offset.

In a twelfth aspect, there is provided an X-ray CT apparatus according to the first aspect, wherein the X-ray irradiator has a collimator for forming the deflected fan-beam X-rays.

In a thirteenth aspect, there is provided an X-ray CT apparatus according to the twelfth aspect, wherein the collimator is comprised of an X-ray blocking material which has an aperture for X-rays to pass through.

In a fourteenth aspect, there is provided an X-ray CT apparatus according to the first aspect, wherein the X-ray irradiator has a filter for the deflected fan-beam X-rays.

In a fifteenth aspect, there is provided an X-ray CT apparatus according to fourteenth aspect, wherein the filter corresponds to one side of a bowtie filter.

In a sixteenth aspect, there is provided an X-ray CT apparatus according to the first aspect, wherein the subject is supported on a table top which is vertically moved by swing of a support.

In a seventeenth aspect, there is provided an X-ray CT apparatus according to the first aspect, wherein the subject is supported on a table top which is vertically moved by extension and contraction of a support.

In an eighteenth aspect, there is provided an X-ray CT apparatus according to the first aspect, wherein the scan control device allows axial scanning to be conducted.

In a nineteenth aspect, there is provided an X-ray CT apparatus according to the first aspect, wherein the scan control device allows helical scanning to be conducted.

In a twentieth aspect, there is provided an X-ray CT apparatus according to the first aspect, wherein the scan control device allows cluster scanning to be conducted.

In some embodiments, an X-ray CT apparatus includes an X-ray irradiator which irradiates fan-beam X-rays; a multi-channel X-ray detector disposed to face the X-ray irradiator; a transmitted X-ray data collection device which scans a subject and collects transmitted X-ray data of two or more views while rotating the X-ray irradiator and the multi-channel X-ray detector; a scan control device which controls the scan; and an image reconstruction device which reconstructs an image based on the transmitted X-ray data. The X-ray irradiator irradiates fan-beam X-rays deflected to one side of the center of rotation, the X-ray detector has a number of channels to cope with a spread of the fan-beam X-rays, and the scan control device allows the X-ray irradiator and the X-ray detector to conduct a scan of at least one rotation. Accordingly, an economical X-ray CT apparatus having a large scan FOV can be obtained. Also, an X-ray CT apparatus achieving the large scan FOV and low exposure at the same time can be obtained.

### BRIEF DESCRIPTION OF THE DRAWINGS

FIG. 1 shows the configuration of an exemplary X-ray CT apparatus according to one example of the best mode for carrying out the invention.

FIG. 2 shows the configuration of a second exemplary embodiment of an X-ray CT apparatus according to one example of the best mode for carrying out the invention.

FIG. 3 shows the configuration of an exemplary X-ray irradiation/detection unit.

FIG. 4 shows the configuration of a second exemplary embodiment of an X-ray irradiation/detection unit.

FIG. 5 is a conceptual diagram of flying focus.

FIG. 6 is a conceptual diagram of transmitted X-ray data which are interleaved.

### DETAILED DESCRIPTION OF THE INVENTION

Embodiments will be now described with reference to the accompanying drawings. Noted is that the present invention is not limited to the embodiments described herein.

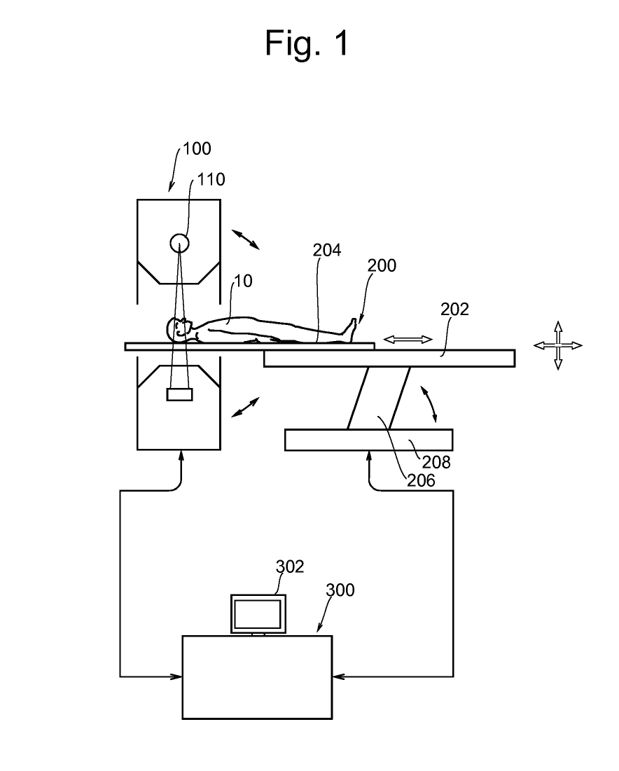

FIG. 1 shows the typical configuration of an exemplary X-ray CT apparatus.

The present apparatus has a gantry 100, a table 200, and an operator console 300. The gantry 100 scans a subject 10 carried in on the table 200 by use of an X-ray irradiation/detection unit 110, collects transmitted X-ray data of two or more views, and inputs them to the operator console 300. Hereafter, the transmitted X-ray data are also called “scan data.”

The operator console 300 reconstructs an image based on the scan data inputted from the gantry 100, and shows the reconstructed image on a display 302. The operator console 300 is an example of the image reconstruction device of the present invention.

The operator console 300 controls the operation of the gantry 100 and the table 200. The operator console 300 is an example of the scan control device of the present invention. Under the control of the operator console 300, the gantry 100 conducts a scan on a predetermined scanning condition, and the table 200 positions the subject 10 so that a predetermined portion may be scanned. A built-in position adjustment mechanism conducts the positioning by adjusting a height of a table top 202 and a horizontal moving distance of a cradle 204 on the table top.

Helical scanning can be conducted by continuously moving the cradle 204 and continuously conducting two or more scans. Cluster scanning can be conducted by intermittently moving the cradle 204 and conducting a scan at every stop position. Axial scanning can be conducted by scanning with the cradle 204 stopped.

The height of the table top 202 is adjusted by swinging a support 206 about an attachment part to a base 208. By the swing of the support 206, the table top 202 is displaced vertically and horizontally. The cradle 204 moves horizontally on the table top 202 to offset the horizontal displacement of the table top 202. Depending on scanning conditions, the scan may be conducted while the gantry 100 is being tilted. The tilting of the gantry 100 is conducted by a built-in tilting mechanism.

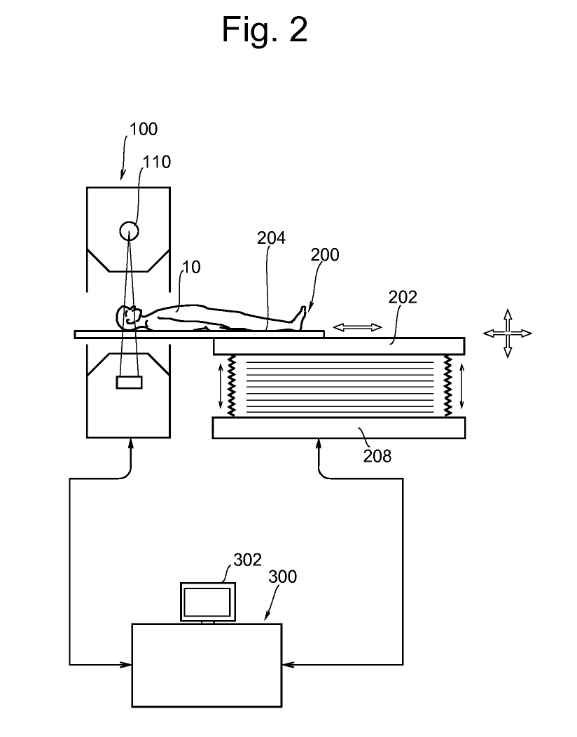

Further, as shown in FIG. 2, the table 200 may be constructed such that the table top 202 goes up and down perpendicularly to the base 208. The table top 202 is allowed to go up and down by a built-in lift mechanism. With regard to the table 200, there is no horizontal movement of the table top 202 caused by its ascent and descent.

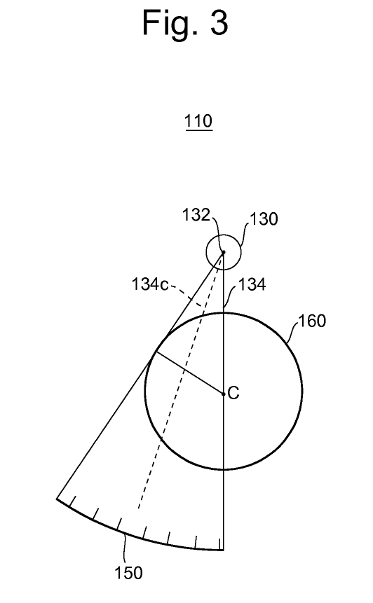

FIG. 3 shows the typical configuration of the X-ray irradiation/detection unit 110. The X-ray irradiation/detection unit 110 detects X-rays 134 irradiated from a focal point 132 of an X-ray irradiator 130 by use of an X-ray detector 150. While keeping this relationship, the X-ray irradiator 130 and the X-ray detector 150 revolve about the scan center C. The X-ray irradiator 130 is an example of the X-ray irradiator according to the present invention. The X-ray detector 150 is an example of the X-ray detector according to the present invention.

The X-rays 134 are shaped by a collimator into fan-beam X-rays. A fan angle of the fan-beam X-rays is a. The X-ray detector 150 has a number of detection channels disposed to cope with a spread of the fan-beam X-rays 134. The detection channels are arranged along a circular arc with the focal point 132 as its center.

The fan-beam X-rays 134 are formed such that its central beam 134c is deflected to one side by an angle equivalent to half of the fan angle a with respect to the scan center C in a plane of the fan beam. Therefore, the X-rays are irradiated to only a half of a scan FOV 160 defined by a circular region concentric with the scan center C.

Although the X-rays are irradiated to the half side alone, by one rotation of the X-ray irradiation/detection unit 110, the entire scan FOV 160 is scanned. Therefore, transmitted X-ray data can be obtained with respect to the entire scan FOV 160. By using such transmitted X-ray data, an image about the entire scan FOV 160 can be reconstructed.

Assuming that a distance from the focal point 132 to the scan center C is D, a size of the scan FOV 160 is expressed as follows:

SFOV size=2×sin(α)×D (1)

On the other hand, when the fan-beam X-rays are not deflected in the same geometry, that is, when the central beam 134c of the fan-beam X-rays 134 passes through the scan center C, the size of the scan FOV is expressed as follows:

SFOV size=2×sin(α/2)×D (2)

When comparing the above two, the angle in the sine term of the case where the fan-beam X-rays 134 are deflected is twice as large as that of the case where the fan-beam X-rays are not deflected. Accordingly, the size of the scan FOV of the case where the fan-beam X-rays 134 are deflected is nearly twice as large as that of the case where the fan-beam X-rays 134 are not deflected.

Since such a large scan FOV is realized without expanding the geometry, both the large scan FOV and economic efficiency can be achieved. Alternatively, when it is not necessary for the scan FOV to be larger than a conventional one, by reducing the number of channels of the X-ray detector to half, the cost reduction can be achieved.

Moreover, since the X-rays are irradiated to only a half of the scan FOV, the amount of exposure is halved as compared to the case where the X-rays are irradiated to the entire scan FOV. Thus, both the large scan FOV and low exposure can be achieved.

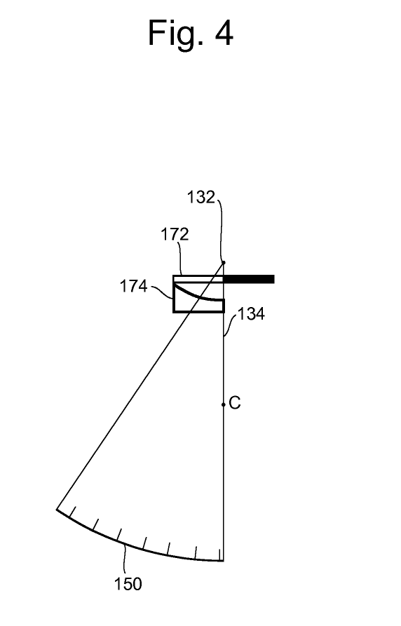

The X-ray irradiator 130 comprises, as shown in FIG. 4, a collimator 172 and a filter 174. As shown in FIG. 4, the collimator 172 applies the fan-beam X-rays 134 to only one side and prevents the irradiation to the other side. An X-ray blocking part is composed of a lead plate or the like. The filter 174 is for optimizing the intensity distribution with respect to the deflected fan-beam X-rays, and is configured to correspond to a half-side portion of a commonly used bowtie filter.

During the scan, the position of the focal point 132 of the X-ray irradiator 130 is dynamically changed. The position of the focal point is changed under the control of the operator console 300. Hereafter, the changing of the focal position during the scan is also called “flying focus.”

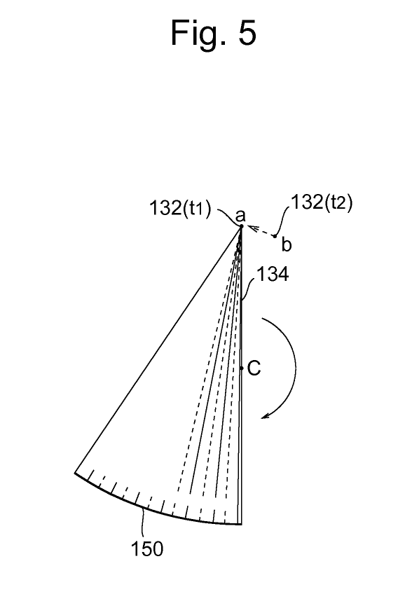

FIG. 5 shows a conceptual diagram of the flying focus. As shown in FIG. 5, at time t1 during the scan, the focal point 132 is located at position a. There, as indicated with solid lines, X-rays enter respective detection channels of the X-ray detector 150. Further, each detection channel is represented by the center of a channel.

The focal point 132 and the X-ray detector 150 rotate by an angle equivalent to ½ of a channel pitch till time t2. Accordingly, the focal point 132 moves to position b, and each detection channel is displaced, as indicated with dashed lines, by half of the channel pitch.

In this state, the focal point 132 is returned to the original position a. Accordingly, X-rays indicated with dashed lines enter respective detection channels. The X-rays in this regard are the ones which are respectively interleaved with X-rays having entered detection channels at time t1.

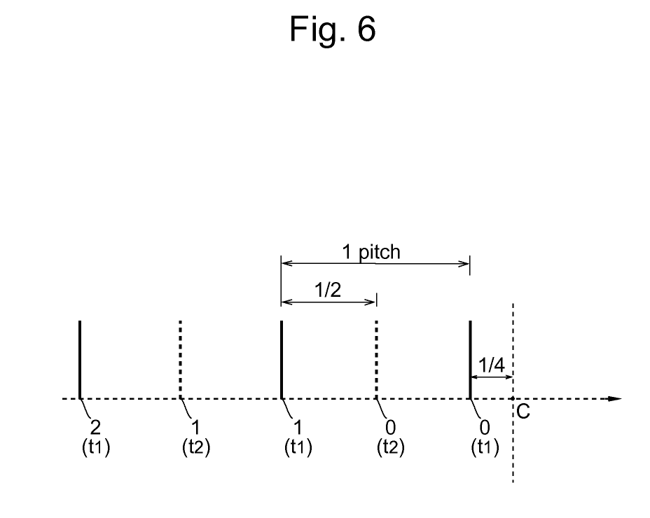

FIG. 6 shows such a relationship in detail about the vicinity of channel 0. In FIG. 6, the channel 0 is a detection channel on an extended portion of a line connecting the focal point 132 with the scan center C. With the channel as a starting point, there proceed channels 1, 2, 3, . . . , in the leftward direction. In this regard, each detection channel is offset to the left by ¼ pitch. However, such an offset is not indispensable.

As shown in FIG. 6, the positions of detection channels are displaced by ½ pitch between time t1 and time t2. At the same time, in both the states, X-rays are applied from the same focal point. Therefore, transmitted X-ray data interleaved by ½ pitch can be obtained.

Such data collection is conducted with respect to all the views, and transmitted X-ray data interleaved by ½ pitch can be obtained with respect to all the views. By reconstructing the image by use of a combination of such transmitted X-ray data, a reconstructed image having a spatial resolution equivalent to half of the channel pitch of the X-ray detector 150 can be obtained.

1. An X-ray CT apparatus comprising:
an X-ray irradiator configured to irradiate fan-beam X-rays;
a multi-channel X-ray detector disposed to face said X-ray irradiator;
a transmitted X-ray data collection device configured to collect transmitted X-ray data of two or more views by performing a scan of a subject while rotating said X-ray irradiator and said X-ray detector;
a scan control device configured to control the scan; and
an image reconstruction device configured to reconstruct an image based on the transmitted X-ray data, wherein said X-ray irradiator is configured to irradiate fan-beam X-rays deflected to one side of the center of rotation, said X-ray detector comprises a plurality of channels to cope with a spread of the fan-beam X-rays, said scan control device is configured to enable said X-ray irradiator and said X-ray detector to conduct a scan of at least one rotation.

2. An X-ray CT apparatus according to claim 1, wherein said X-ray irradiator is configured to irradiate fan-beam X-rays having a central beam that is deflected to one side by an angle equivalent to 1/n of a fan angle relative to the center of the scan in a plane of the fan beam.

3. An X-ray CT apparatus according to claim 2, wherein the central beam is deflected to one side by an angle equivalent to ½ of the fan angle relative to the center of the scan in the plane of the fan beam.

4. An X-ray CT apparatus according to claim 1, wherein said scan control device comprises a control device configured to control X-ray irradiation by said X-ray irradiator in two or more different relative positional relationship between said X-ray irradiator and said X-ray detector, said image reconstruction device is configured to reconstruct the image based on a combination of the transmitted X-ray data at the two or more different relative positions collected by said transmitted X-ray data collection device.

5. An X-ray CT apparatus according to claim 4, wherein said scan control device is configured to adjust, in relation to each view, positions of an X-ray focal point of said X-ray irradiator in a scanning trajectory to be the same with respect before the amount of rotation of the scan becomes equivalent to half of a channel pitch of said X-ray detector and after the amount of rotation of the scan becomes equivalent to half of the channel pitch of said X-ray detector.

6. An X-ray CT apparatus according to claim 5, wherein said scan control device is configured to adjust positions of the X-ray focal point by flying focus.

7. An X-ray CT apparatus according to claim 5, wherein said image reconstruction device is configured to reconstruct the image based on a combination of transmitted X-ray data obtained when adjusting said positions of the X-ray focal point in respective views.

8. An X-ray CT apparatus according to claim 7, wherein said combination of the transmitted X-ray data is the one being interleaved.

9. An X-ray CT apparatus according to claim 1, wherein said X-ray detector is disposed such that it is offset toward channels.

10. An X-ray CT apparatus according to claim 9, wherein said offset is a 1/n offset.

11. An X-ray CT apparatus according to claim 10, wherein said offset is a ¼ offset.

12. An X-ray CT apparatus according to claim 1, wherein said X-ray irradiator comprises a collimator configured to form deflected fan-beam X-rays.

13. An X-ray CT apparatus according to claim 12, wherein said collimator further comprises an X-ray blocking material which has an aperture for X-rays to pass through.

14. An X-ray CT apparatus according to claim 1, wherein said X-ray irradiator comprises a filter for the deflected fan-beam X-rays.

15. An X-ray CT apparatus according to claim 14, wherein said filter corresponds to one side of a bowtie filter.

16. An X-ray CT apparatus according to claim 1, wherein the subject is supported on a table top which is configured to move vertically by swing of a support.

17. An X-ray CT apparatus according to claim 1, wherein the subject is supported on a table top which is configured to move vertically by extension and contraction of a support.

18. An X-ray CT apparatus according to claim 1, wherein said scan control device allows axial scanning to be conducted.

19. An X-ray CT apparatus according to claim 1, wherein said scan control device allows helical scanning to be conducted.

20. An X-ray CT apparatus according to claim 1, wherein said scan control device allows cluster scanning to be conducted.
